(19) United States
(12) Patent Application Publication
(10) Pub. No.: US 2005/0248702 A1
(43) Pub. Date: Nov. 10, 2005

(54) Reflective bistable nematic liquid crystal display device

(75) Inventor: Toshiaki Hoshino, Tokyo (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/121,411

(22) Filed: May 4, 2005

(30) Foreign Application Priority Data
May 10, 2004 (JP) 2004-139526

(51) Int. Cl. G02F 1/1335

(52) U.S. Cl. 349/113

(57) ABSTRACT

A reflective bistable nematic liquid crystal display device includes a liquid crystal cell and a reflector provided on a side of the liquid crystal cell opposite to an observer side, with a transmissive adhesive layer interposed therebetween. The liquid crystal cell includes a pair of substrates opposite to each other, with a nematic liquid crystal layer in which a chiral agent is added therebetween, in which one of the pair of substrates has an alignment film with strong anchoring energy and the other has an alignment film with weak anchoring energy. The alignment film having the weak anchoring energy has anchoring energy smaller than half of that of the alignment film having strong anchoring energy and has a pre-tilt angle of about 0°.

### BACKGROUND OF THE INVENTION

1. Field of the Invention

The present invention relates to a reflective bistable nematic liquid crystal display device applicable to electronic apparatuses, such as an electronic book and an electronic organizer in which data that has been displayed, such as characters, is maintained for a long time until the data is reset.

2. Description of the Related Art

A bistable nematic liquid crystal display device using nematic liquid crystal has been known as a kind of simple matrix liquid crystal display device. Since the bistable liquid crystal display device does not use active elements, such as thin film transistors (TFTs), the device has a high response speed and thus can hold data that has been displayed for a long time. Thus, this bistable liquid crystal display device has attracted much attention.

In a conventional bistable nematic liquid crystal display device, nematic liquid crystal is held between a pair of upper and lower substrates at a predetermined cell gap, an alignment film having strong anchoring energy (strong alignment force) is provided on an inner surface of one substrate. In addition, another alignment film having weak anchoring energy (weak alignment force) is provided on an inner surface of the other substrate.

A conventional alignment film having strong anchoring energy is generally formed by performing a rubbing process on an organic alignment film made of, for example, polyimide, polyamide, or polyvinyl alcohol, and the alignment film having weak anchoring energy is formed by irradiating light onto an organic alignment film made of, for example, polyimide, or an SiOₓ film formed by an oblique deposition method to change the property thereof, or by cleaning the organic alignment film with a solvent (for example, Ph. Martinot-Lagarde et al., Fast Bistable Nematic Display Using Monostable Surface Switching, Digest of SID'97, 1997, p. 41 to 44).

This bistable nematic liquid crystal display device can have two different stable states (bistable state) by a difference in voltage applied, and such a display method is called a bistable mode.

Further, the substrate provided with the alignment film having strong anchoring energy is called a master substrate, and the substrate provided with the alignment film having weak anchoring energy is called a slave substrate.

However, it is difficult to apply the conventional bistable nematic liquid crystal display device to a monochrome-display-type transmissive liquid crystal display device (for example, Japanese Unexamined Patent Application Publication No. 7-72487). In the transmissive liquid crystal display device, a backlight unit is provided on the rear side of a liquid crystal panel, and light emitted from the backlight unit is used as illumination light, which results in a large amount of power consumption.

In order to reduce the power consumption, it is considered that the bistable nematic liquid crystal display device is applied to a reflective display device. However, it is difficult to provide two alignment films respectively having strong and weak anchoring energies in a liquid crystal cell in which a reflector having an uneven reflective surface, such as a diffusing reflection surface or a light scattering surface, is provided on a surface thereof, with high stability and reproducibility, by controlling the anchoring of the alignment films. This is because, in a bistable mode, it is necessary to reduce a gap between the films, from the viewpoint of the anchoring control of the two alignment films having strong and weak anchoring energies, which causes a manufacturing process to become complicated. In addition, when the alignment films having strong and weak anchoring energies are provided on the unevenness surface of the reflector, the manufacturing process is further complicated, which makes it difficult to provide the two alignment films having strong and weak anchoring energies with high stability and reproducibility.

### SUMMARY OF THE INVENTION

The invention is designed to solve the above-mentioned problems, and it is an object of the invention to provide a reflective bistable nematic liquid crystal display device in which two alignment films having storing and weak anchoring energies are stably provided and which can be manufactured with a simple manufacturing process.

In order to achieve the above object, according to an aspect of the invention, a reflective bistable nematic liquid crystal display device includes a liquid crystal cell, and a reflector provided on a side of the liquid crystal cell opposite to an observer side, with a transmissive adhesive layer interposed therebetween. In addition, the liquid crystal cell includes a pair of substrates and a nematic liquid crystal layer in which a chiral agent is added, in which one of the pair of substrates has electrodes and an alignment film with strong anchoring energy in this order on a surface thereof facing the liquid crystal layer, and the other of the pair of substrates has electrodes and an alignment film with weak anchoring energy in this order on a surface thereof facing the liquid crystal layer. The alignment film having the strong anchoring energy is formed to have a predetermined pre-tilt angle. In addition, the alignment film having the weak anchoring energy is composed of a polymer film having shape anisotropy on at least one surface thereof and is formed to have anchoring energy smaller than half of that of the alignment film having strong anchoring energy and to have a pre-tilt angle of about 0°. Further, a surface of the reflector facing the liquid crystal cell serves as a diffusing reflection surface having unevenness or a plurality of concave portions thereon, and liquid crystal molecules of the liquid crystal layer in the liquid crystal cell are controlled to be arranged in one of two stable states.

According to the reflective bistable nematic liquid crystal display device having the above-mentioned structure, the reflector is provided on a side of the liquid crystal cell opposite to the observer side, with the transmissive adhesive layer interposed therebetween. Therefore, when the two alignment films having strong and weak anchoring energies are formed in the liquid crystal cell, it is possible to reduce a gap therebetween without being affected by the surface shape of the reflector, by controlling strong and weak anchoring energies. Thus, the two alignment films having strong and weak anchoring energies can be more stably provided, and a manufacturing process thereof can be simplified.

Further, an alignment film provided on one substrate can be composed of a polymer film having shape anisotropy on at least one surface, which makes it possible to set weak alignment force in the azimuth direction and/or the polar angle direction while maintaining an azimuth on the surface of the alignment film provided on one substrate. The alignment film having weak anchoring energy on a surface thereof can be easily manufactured by, for example, a transfer method in which a transfer mold having, on its surface, a minute unevenness pattern to be transferred is pressed against a layer made of a polymer material that is formed on a substrate 20 with an electrode layer therebetween, thereby transferring the minute unevenness pattern onto the layer. Therefore, it is possible to perform an alignment process without using a large vacuum apparatus.

Furthermore, it is possible to adjust alignment force by changing the pattern to be formed on the surface of a polymer film. In addition, the alignment film having weak anchoring energy has anchoring energy smaller than half of that of the alignment film having strong anchoring energy. Therefore, it is possible to obtain stable initial alignment, and to switch one of two stable states to the other stable state with high reproducibility according to a voltage applied.

Moreover, in the bistable nematic liquid crystal display device of the invention having the above-mentioned structure, it is preferable that the alignment film having weak anchoring energy have an anchoring energy of 6×10⁻⁵ J/m² to 2×10⁻⁴ J/m².

Further, according to the bistable nematic liquid crystal display device of the invention having the above-mentioned structure, preferably, in the reflector, a plurality of reflective concave portions is formed on a base substrate, and each of the plurality of reflective concave portions has a curved internal surface. In addition, each concave portion has a specific vertical section passing through a lowest point thereof, and the specific vertical section is composed of a first curve linking a circumferential portion of the concave portion to the lowest point and a second curve connected to the first curve to link the lowest point to another circumferential portion. Further, an average value of the absolute values of tilt angles of the first curve with respect to a surface of the base substrate is larger than an average value of the absolute values of tilt angles of the second curve with respect to the surface of the base substrate, and a maximum value of the absolute values of the tilt angles of the first curve with respect to the surface of the base substrate is in the range of 4° to 35°. In addition, the plurality of concave portions are irregularly formed with a depth of 0.1 μm to 3 μm, and the base substrate is obliquely provided with respect to a horizontal surface such that the second curve of each concave portion is placed downward at a position close to an observer and the first curve thereof is placed upward at a position separated from the observer.

The reflector having the above-mentioned structure is referred to as an asymmetric dimple reflector.

In this bistable nematic liquid crystal display device, the asymmetric dimple reflector having the above-mentioned structure is provided on a side of the liquid crystal cell opposite to the observer side with the transmissive adhesive layer interposed therebetween. Therefore, incident light is diffusively reflected from a diffusing reflection surface having a plurality of concave portions on a surface thereof, which makes it possible to obtain a light diffusion property of suppressing that light emitted from a light source or a facial image of an observer is reflected from a display surface in the wide viewing angle range, and to increase the amount of light in the general viewing angle range of the observer. In addition, it is possible to control the brightness of reflected light and the viewing angle characteristic such that the desired viewing angle dependence of a liquid crystal display device is obtained.

Furthermore, in the bistable nematic liquid crystal display device of the invention, preferably, a plurality of concave portions whose internal surfaces each constitute a portion of a spherical surface are consecutively formed in a shape corresponding to the shape of the indenter on a surface of the reflector facing the liquid crystal cell such that the edges of adjacent concave portions overlap each other, by pressing the indenter whose tip has a spherical shape against the base substrate at a random pitch and a random depth. In addition, it is preferable that the concave portions be randomly formed with a depth of 0.1 to 3 μm, that a pitch between adjacent concave portions be randomly set, and that the tilt angle of the internal surface of each concave portion have a uniform angular distribution within the range of −10° to +10°.

The reflector having the above-mentioned structure is referred to as a first symmetric dimple reflector.

In the reflector included in the bistable nematic liquid crystal display device, a plurality of concave portions whose internal surfaces each constitute a portion of a spherical surface are consecutively formed in a shape corresponding to the shape of the indenter on a surface of the reflector such that the edges of adjacent concave portions overlap each other, by pressing the indenter whose tip has a spherical shape against the surface at a random pitch and a random depth. In this way, the depth of the concave portion is defined, and the pitch between adjacent concave portions is randomly set, so that the tilt angle of the internal surface of each concave portion has a substantially uniform angular distribution within a predetermined range. Therefore, uniform reflection efficiency is obtained in all directions, and thus light having various wavelengths can be reflected with a good balance. That is, it is possible to realize a bright, white reflector as viewed from any direction.

In the reflector provided on the side of the liquid crystal cell opposite to the observer side, it is important that the tilt angle of the internal surface of each concave portion formed on the diffusing reflection surface be set to have a uniform angular distribution in the range of −10° to +10°, and that the pitches between adjacent concave portions 74 be randomly set in all directions on the plane.

The reason is that, if the pitches between adjacent concave portions are regularly set, interference colors of light occur, which causes reflected light to be colored.

Further, when the depth of the concave portion is larger than 3 μm, the top of the concave portion is not buried with an adhesive layer in a subsequent process of planarizing the concave portion 74, and thus desired flatness is not obtained.

Therefore, for the sake of convenience, when a diamond indenter having a diameter of 30 to 100 μm is used for manufacturing a mother die for forming a reflector, it is preferable that the pitch between adjacent concave portions be set in the range of 5 to 50 μm.

According to the reflective bistable nematic liquid crystal display device having the above-mentioned structure, the reflector having the above-mentioned good characteristic is provided on the side of the liquid crystal cell opposite to the observer side. Therefore, it is possible to realize a liquid crystal display device having a wide viewing angle and a bright display surface.

Furthermore, in the reflective bistable nematic liquid crystal display device of the invention, a plurality of concave portions whose internal surfaces each constitute a portion of a spherical surface are consecutively formed in a shape corresponding to the shape of the indenter on a surface of the reflector facing the liquid crystal cell such that the edges of adjacent concave portions overlap each other, by pressing the indenter whose tip has a spherical shape against the base substrate at a random pitch and a random depth. In addition, the concave portions are randomly formed with a depth of 0.1 to 3 μm, and a pattern in which a pitch between adjacent concave portions is randomly set is repeatedly arranged to form a surface of the reflector. Further, the tilt angle of the internal surface of each concave portion has a uniform angular distribution within the range of −10° to +10°, and a diffusion angle of reflected light is set in a predetermined angular range on the entire surface of the reflector. In addition, a pattern in which the concave portions having different depths, pitches, and diameters are formed in a region defined by predetermined rows and columns is repeatedly formed in succession, so that the concave portions are randomly formed on the entire surface of the reflector.

The reflector having the above-mentioned structure is referred to as a second symmetric dimple reflector.

According to the reflector having the above-mentioned structure, a pattern in which the distribution of the tilt angles of the internal surface of each concave portion is substantially uniform in all directions on the reflector is repeatedly arranged on the entire surface of the reflector, thereby forming the reflector.

Moreover, in the reflective bistable nematic liquid crystal display device of the invention, a plurality of concave portions is formed on a mother substrate by pressing an indenter whose tip has a spherical shape against the mother substrate such that the depths of the plurality of concave portions are randomly set by the pressed depth of the indenter, such that pitches between the concave portions are randomly set by the pressed position of the indenter, and such that the edges of adjacent concave portions overlap each other. Then, a transfer mold is formed from the mother substrate by a transfer method. In addition, a reflector is formed by transferring an unevenness pattern of the transfer mold onto a resin layer, so that a plurality of concave portions whose internal surfaces each constitute a portion of a spherical surface are consecutively formed in a shape corresponding to the shape of the indenter on a surface of the reflector. Further, the concave portions are randomly formed with a depth of 0.1 to 3 μm, and a pattern in which the concave portions having different depths, pitches, and diameters are formed in a region defined by predetermined rows and columns is repeatedly formed in succession, so that the concave portions are randomly formed on the entire surface of the reflector.

The reflector having the above-mentioned structure is referred to as a third symmetric dimple reflector.

According to the reflector having the above-mentioned structure, it is possible to obtain uniform reflection efficiency in all directions, and to reflect light having various wavelengths with a good balance. Thus, it is possible to realize a bright, white reflector, as viewed from any direction.

Further, in the reflective bistable nematic liquid crystal display device of the invention, preferably, one of the pair of substrates of the liquid crystal cell, the substrate being provided at a side opposite to the observer side, has a light scattering surface having a light scattering property on a surface thereof facing the reflector, and the light scattering surface has unevenness thereon.

According to the bistable nematic liquid crystal display device having the above-mentioned structure, an unevenness pattern is formed on a surface of the substrate facing the reflector. Therefore, it is possible to endow a light scattering property suitable for this surface. In addition, this light scattering surface is provided between the diffusing reflection surface and the liquid crystal layer. Thus, even if a spectrum occurs in light reflected from the diffusing reflection surface of the reflector by the unevenness of the diffusing reflection surface, a rainbow does not occur in a display screen since the light is scattered when passing through the light scattering surface.

### BRIEF DESCRIPTION OF THE DRAWINGS

FIG. 1 is a cross-sectional view partially illustrating the sectional structure of a reflective bistable nematic liquid crystal display device according to an embodiment of the invention;

FIG. 2 is a perspective view illustrating an alignment film having weak anchoring energy included in the liquid crystal display device shown in FIG. 1;

FIG. 3 is a cross-sectional view of unevenness taken along a second direction of the alignment film having weak anchoring energy shown in FIG. 2;

FIG. 4 is a perspective view illustrating a portion of an asymmetric dimple reflector included in the reflective bistable nematic liquid crystal display device of the invention;

FIG. 5 is a perspective view illustrating a concave portion formed on the asymmetric dimple reflector shown in FIG. 4;

FIG. 6 is a cross-sectional view of a concave portion formed on the asymmetric dimple reflector shown in FIG. 4 that is taken along a specific vertical section;

FIG. 7 is an explanatory diagram illustrating a reflection characteristic of the asymmetric dimple reflector shown in FIG. 4;

FIG. 8 is a graph illustrating the relationship between an acceptance angle and reflectance;

FIG. 9 is an explanatory diagram illustrating the state of use of the reflective bistable nematic liquid crystal display device of the invention;

FIG. 10 is a perspective view illustrating a portion of a symmetric dimple reflector included in the reflective bistable nematic liquid crystal display device of the invention;

FIG. 11 is a flow diagram illustrating a process of manufacturing the symmetric dimple reflector shown in FIG. 10;

FIG. 12 is a view illustrating a process of manufacturing a mother die used for forming the symmetric dimple reflector shown in FIG. 10, and shows a state in which a diamond indenter is pressed against a mother substrate;

FIG. 13 is a plan view illustrating a pattern obtained by the rolling of the diamond indenter in the manufacturing process of the mother die;

FIG. 14 is a plan view illustrating the shape of all concave portions after the rolling process;

FIG. 15 is a graph illustrating the distribution of tilt angles of an internal surface of a concave portion in the symmetric dimple reflector shown in FIG. 10;

FIG. 16 is a view illustrating the tilt angles of the internal surface of the concave portion in the symmetric dimple reflector shown in FIG. 10; and

FIG. 17 is a cross-sectional view partially illustrating the sectional structure of a reflective bistable nematic liquid crystal display device according to another embodiment of the invention in which a light scattering surface is formed on a surface of a substrate facing a reflector, that substrate being arranged on a side opposite to the observer side.

### DESCRIPTION OF THE PREFERRED EMBODIMENT

Hereinafter, a reflective bistable nematic liquid crystal display device according to an embodiment of the invention will be described with the accompanying drawings. However, the invention is not limited to the following embodiment.

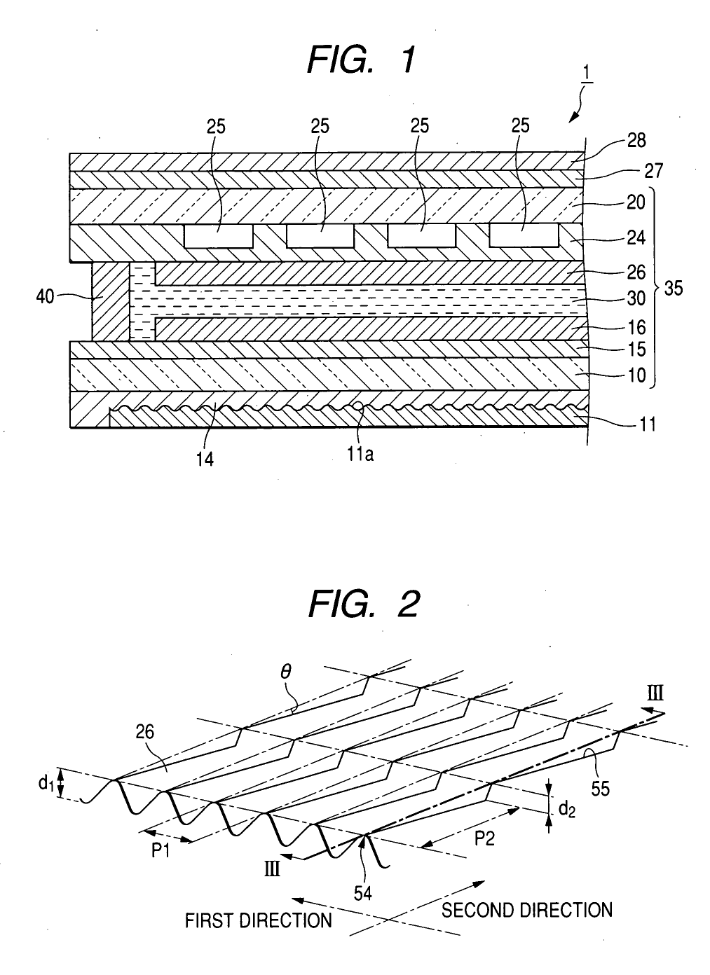

FIG. 1 is a schematic cross-sectional view partially illustrating the sectional structure of the reflective bistable nematic liquid crystal display device according to an embodiment of the invention.

In FIG. 1, a reflective bistable nematic liquid crystal display device 1 of the invention is formed by bonding a first substrate 10 to a second substrate 20 (a pair of substrates), with a chiral nematic liquid crystal layer 30 interposed therebetween, using a ring-shaped sealing member 40 provided at the edges of the two substrates 10 and 20.

A first electrode layer (electrode) 15 for driving the liquid crystal layer 30, a top coating film (not shown) composed of an insulating film, and a first alignment film 16 for controlling the alignment of liquid crystal molecules constituting the liquid crystal layer 30 are formed in this order on a surface of the first substrate 10 facing the liquid crystal layer 30. In addition, a second electrode layer (electrode) 25, a top coating film (insulating film) 24, and a second alignment film 26 are formed in this order on a surface of the second substrate facing the liquid crystal layer 30.

A liquid crystal cell 35 is composed of the first substrate 10, the second substrate 20, and various components provided therebetween.

Further, one or more retardation plates 27 and polarizing plates 28 are provided on an observer side of the liquid crystal cell 35 (on a surface of the second substrate 20 opposite to the liquid crystal layer 30). The side of polarizing plate 28 is the observer side.

A reflector 11 is provided on a side of the liquid crystal cell 35 opposite to the observer side (on a surface of the first substrate 10 opposite to the liquid crystal layer 30) with a transmissive adhesive layer 14 interposed therebetween.

The first and second substrates 10 and 20 are composed of transparent substrates made of, for example, glass.

The first electrode layer 15 is formed by aligning, on the first substrate 10, a plurality of transparent conductive films having a stripe shape in plan view that are made of, for example, ITO (indium tin oxide). The first electrode layer 15 is connected to a scanning electrode driving circuit (not shown). Similarly, The second electrode layer 25 is also formed by aligning, on the second substrate 20, a plurality of transparent conductive films having a stripe shape in plan view that are made of, for example, ITO. The second electrode layer 25 is connected to a signal electrode driving circuit (not shown) 25a.

Furthermore, the first electrode layer 15 and the second electrode layer 25 are arranged so as to face each other at a right angle in plan view, so that the liquid crystal display device 1 becomes a passive matrix liquid crystal display device.

The first alignment film 16 is an alignment film having strong anchoring energy which has been used in the related art, and is formed by performing a rubbing process on an organic alignment film made of polyimide, polyamide, or polyvinyl alcohol. The anchoring energy at that time is 10⁻³ J/m².

Further, pre-tilt angles of the liquid crystal molecules with respect to the first alignment film 16 are changed according to the type of liquid crystal used for the liquid crystal layer 30. The liquid crystal molecules are generally inclined at an angle of 2° to 7°, and preferably, an angle of 2° to 5°.

The second alignment film 26 is an alignment film having weak anchoring energy that is composed of a polymer film having shape anisotropy thereon, and is formed at a pre-tilt angle of about 0°, preferably a pre-tilt angle smaller than 1°, and more preferably a pre-tilt angle smaller than 0.5°. The anchoring energy of the second alignment film 26 is equal to or smaller than half of that of the alignment film having strong anchoring energy that constitutes the first alignment film 16.

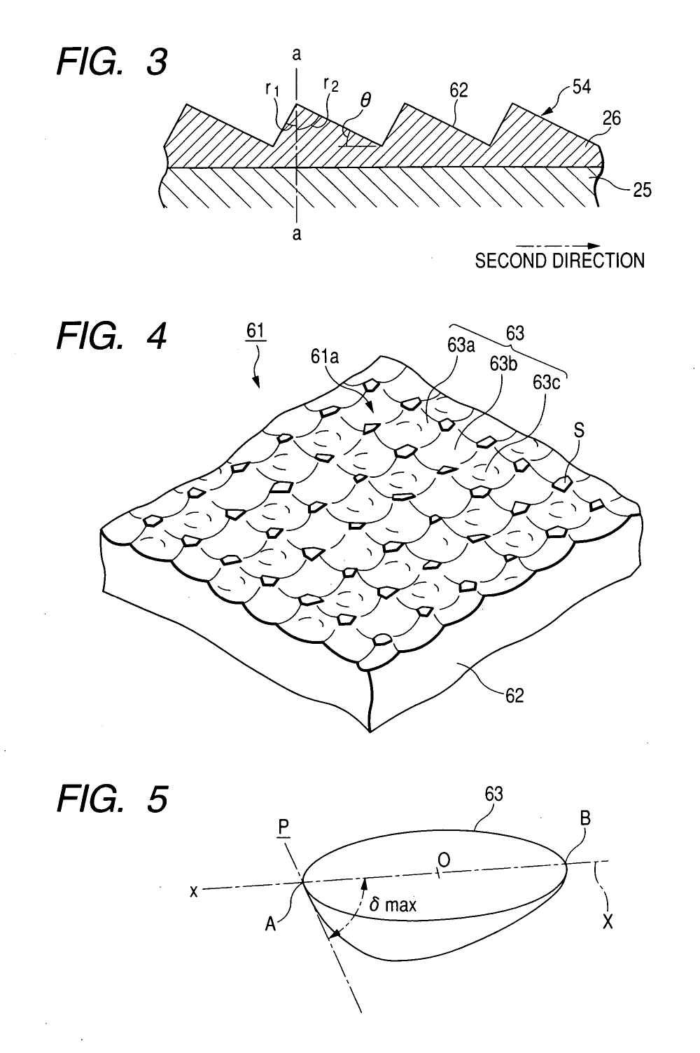

Technical details of alignment control are described in SID93 DIGEST, which is a non-patent document, page 957 (1993), complied by the inventors. As shown in FIGS. 2 and 3, minute unevenness is formed along a first direction, and minute unevenness is also formed in a second direction orthogonal to the first direction on the second alignment film 26. In addition, FIG. 3 is a cross-sectional view taken along the line III-III of FIG. 2 and shows the cross-section of convex stripes formed along the second direction.

Further, a pitch P1 between convex portions formed along the first direction is smaller than a pitch P2 between convex portions formed along the second direction. The pitch P1 is not more than 3.0 μm, preferably within the range of 0.05 μm to 0.5 μm. In addition, the pitch P2 is not more than 50 μm, preferably within the range of 0.5 μm to 5 μm.

As described above, the pitch P2 is greater than the pitch P1, which makes it possible to easily control the pre-tilt angle.

Furthermore, a depth d₁ of a concave portion formed along the first direction (or the height of the convex portion formed along the first direction) is not more than 0.5 μm, preferably within the range of 0.01 μm to 0.2 μm. In addition, a depth d₂ of a concave portion formed along the second direction (or the height of the convex portion formed along the second direction) is not more than 0.5 μm, preferably within the range of 0.01 μm to 0.2 μm.

Moreover, in order to obtain a desired alignment force without generating a domain, a tilt angle θ of an inclined plane 55 of the minute concave and convex portions with respect to the substrate 20 is preferably greater than 0° and not more than 3°. When the tilt angle is zero, generation of the domain becomes remarkable. When the tilt angle is greater than 3°, the alignment force is gradually reduced.

Further, as shown in FIG. 3, each concave portion of the minute concave and convex portions formed along the second direction has an asymmetric triangular shape. That is, each concave portion is formed in a triangle in which, when two angles obtained by dividing a vertical angle thereof by a normal line passing through an apex thereof are r₁ and r₂, respectively, a ratio of r₁ to r₂ is not 1:1. The transverse section of the convex portion 54 has various shapes, such as a shape similar to a sine wave, a comb teeth shape, and a triangular shape. Among them, the triangular shape is most preferable in order to improve the alignment of liquid crystal. In this case, an apex of the triangle may be rounded or truncated. When the convex stripe 54 having a triangular transverse section is used, it is preferable that a ratio of the two angles r₁ and r₂ obtained by dividing a vertical angle of a triangle by the normal line passing through an apex thereof be larger than 1:1.2. When the two angles are set to this angular ratio, it is possible to form a pre-tilt angle of about 0°.

The second alignment film 26 has a thickness of about 50 to 200 nm.

When the shape anisotropy is given to the second alignment film 26 such that the pitches P1 and P2 and the tilt angle θ are set within the above-mentioned ranges, it is preferable that the anchoring energy of the second alignment film 26 be controlled within the range of 6×10⁻⁵ J/m² to 2×10⁻⁴ J/m², preferably about 1×10⁻⁴ J/m². When the anchoring energy of the second alignment film 26 is smaller than 6×10⁻⁵ J/m², the generation of the domain becomes remarkable, and bistable alignment is not achieved. On the other hand, when the anchoring energy of the second alignment film 26 is greater than 2×10⁻⁴ J/m², monostable alignment is easily obtained, which is unsuitable for bistable arrangement.

Further, the polymer film used for the second alignment film 26 is made of a material that can be distorted by shearing force before hardening and/or a material that can be plastically deformed (that can plastically flow) by stress. For example, the material is properly selected from a polyimide-based resin, a polyamide-based resin, a polyvinyl alcohol-based resin, an epoxy-based resin, a denatured epoxy-based resin, a polystyrene-based resin, a polyurethane-based resin, a polyolefin-based resin, an acryl-based resin, etc.

The second alignment film 26 can be easily formed by, for example, a transfer method in which a transfer mold having, on its surface, a minute unevenness pattern (a minute unevenness pattern for forming the minute concave and convex portions along the first direction and the minute concave and convex portions along the second direction) to be transferred is pressed against a layer made of the polymer material that is formed on the substrate 20 (on the surface facing the liquid crystal layer) with the second electrode layer 25 and the top coating film 24 interposed therebetween, thereby transferring the minute unevenness pattern onto the layer.

The transfer mold is manufactured as follows. First, a grating mold is manufactured by a holographic interference using a laser beam having a double copy rate. The same minute unevenness pattern as that to be formed on the second alignment film 26 is formed on the grating mold.

When, the grating mold is pressed against a silicon layer, a reverse pattern of the unevenness pattern of the grating mold is formed on the silicon layer, and then the grating mold is peeled off, thereby obtaining a transfer mold composed of the silicon layer.

The liquid crystal layer 30 is formed by adding a chiral agent to nematic liquid crystal.

The nematic liquid crystal is obtained by performing a terminal group substitution on a biphenyl-based material, a terphenyl-based material, a phenylcycloxesane-based material, a biphenylcycloxesane-based material, a cyclohexylcarboxylic acid ester-based material, a pyrimidine-based material, etc., so that the materials can have a positive or negative dielectric anisotropy, and by mixing plural kinds of the compounds so as to have a desired characteristic.

In addition, a cholesteric-based compound, such as cholesteryl nonanoate, or a kind of nematic liquid crystal having asymmetric carbon, such as CB-15, is used as the chiral agent.

The retardation (Δnd) of the liquid crystal cell 35 is preferably, for example, ¼λ.

Further, a surface of the reflector 11 facing the liquid crystal cell is a diffusing reflection surface 11a having convex and concave portions or a plurality of concave portions thereon. An asymmetric dimple reflector or a symmetric dimple reflector, which will be described later in detail, is preferably used as the reflector 11. More preferably, the asymmetric dimple reflector is used as the reflector 11.

The transmissive adhesive layer 14 is made of a material having a different refractive index from that of the adjacent first substrate 10, in addition to having high reliability as an adhesive and a characteristic not to generate air bubbles. The transmissive adhesive layer 14 is made of, for example, a transparent resin adhesive, such as epoxy resin containing fluorine.

The liquid crystal layer 30 of the reflective bistable nematic liquid crystal display device is a memory stable type in which liquid crystal molecules are horizontally aligned in the same direction in an initial state (that is, liquid crystal has a twist angle of 0°), and in which, after a voltage is applied in the initial state for generating the Fredericks dislocation, the liquid crystal molecules turn to a bistable state different from the initial state by a difference in the applied voltage. For example, when a dark state (black display) refers to a state in which the liquid crystal molecules having the horizontal arrangement in the initial state are twisted by 180° after a voltage is applied, a bright state refers to a state in which the liquid crystal molecules are horizontally aligned in the same direction, that is, the liquid crystal molecules have a twist angle of 0°. In addition, the alignment regulating force of the second alignment film 26 can be controlled in a wide range by controlling surface shape parameters (for example, the pitch, depth, and tilt angle of a groove-shaped structure) as well as the material forming the second alignment film 26.

According to the bistable nematic liquid crystal display device of the present embodiment, the reflector 11 is provided on a surface of the liquid crystal cell 35 opposite to the observer side, with the adhesive layer 14 interposed therebetween. Therefore, when two alignment films having strong and weak anchoring energies are formed in the liquid crystal cell, it is possible to narrow a gap therebetween without being affected by the surface shape of the reflector, from the viewpoint of the control of the two alignment films having strong and weak anchoring energies. Thus, the two alignment films having strong and weak anchoring energies can be more stably provided, and a manufacturing process thereof can be simplified.

Further, since the second alignment film 26 having weak anchoring energy has anchoring energy smaller than half of that of the alignment film having strong anchoring energy, its initial alignment state is stabilized. In particular, the second alignment film 26 can stably have weak alignment regulating force in the initial alignment state. In addition, it is possible to perform switching between the horizontal arrangement in which the liquid crystal molecules have a twist angle of 0° and the twist arrangement in which the liquid crystal molecules have a twist angle of 180° with good reproducibility.

(Example of Asymmetric Dimple Reflector)

FIG. 4 is a view illustrating an asymmetric dimple reflector 61 used for the reflector 11 according to the present embodiment. As shown in FIG. 4, in the asymmetric dimple reflector 61 of the present embodiment, a plurality of reflective concave portions 63a, 63b, 63c, (which are generally referred to as concave portions 63) are formed on a surface S of a plate-shape base substrate 62 made of, for example, aluminum, so as to be irregularly adjacent to each other. Further, a surface of the asymmetric dimple reflector 61 having the plurality of concave portions 63 thereon functions as a diffusing reflection surface 61a.

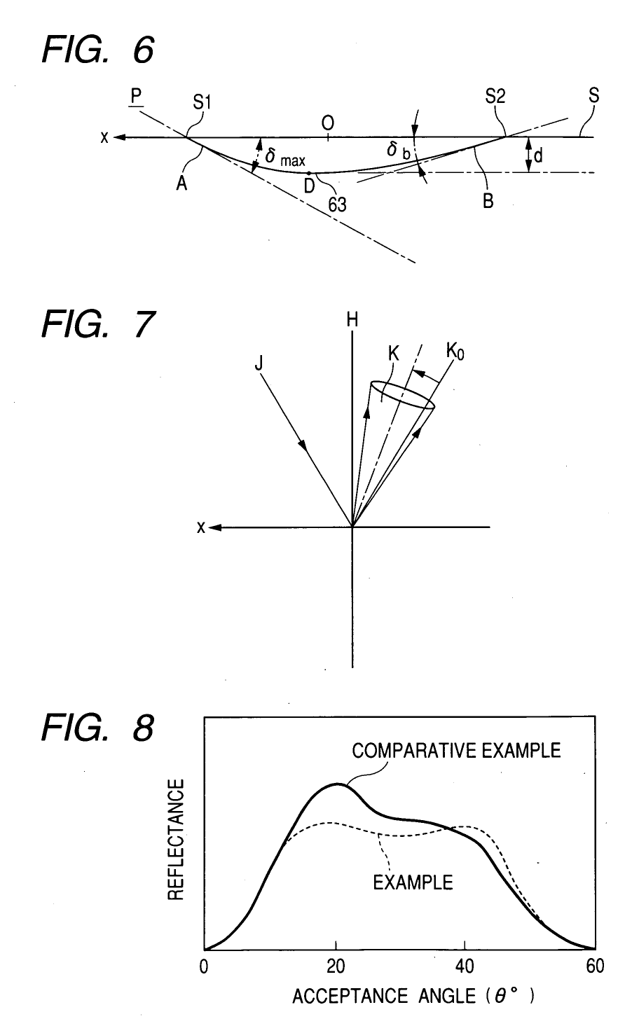

FIGS. 5 and 6 are a perspective view and a cross-sectional view illustrating one concave portion 63, respectively. As shown in FIGS. 5 and 6, an inner surface of the concave portion 63 in a specific vertical section X is composed of a first curve A linking a circumferential portion S1 of the concave portion to a lowest point D and a second curve B that is connected to the first curve A and that links the lowest point D of the concave portion to another circumferential portion S2. The curves both have a tilt angle of 0° with respect to the surface S of the base substrate at the lowest point D, and are connected to each other at that point.

A tilt angle of the first curve A with respect to the surface S of the base substrate is larger than that of the second curve B with respect to the surface S, and the lowest point D is located to be deviated from a center O of the concave portion 63 in the x direction. That is, the average value of the absolute values of the tilt angles of the first curve A with respect to the surface S of the base substrate is larger than that of the absolute values of the tilt angles of the second curve B with respect to the surface S of the base substrate. In the concave portions 63a, 63b, 63c, and the like, the average value of the absolute values of the tilt angles of the first curve A with respect to the surface S of the base substrate varies irregularly within the range of 1 to 89°. Further, in the concave portions 63a, 63b, 63c, and the like, the average value of the absolute values of the tilt angles of the second curve B with respect to the surface S of the base substrate varies irregularly within the range of 5 to 88°.

Since the tilt angles of the two curves gently vary, a maximum tilt angle δmax (an absolute value) of the first curve A is larger than a maximum tilt angle (an absolute angle) δmax of the second curve. In addition, an tilt angle of the lowest point D where the first curve A and second curve B are linked to each other with respect to the surface of the base substrate is zero, and the first curve A having a positive tilt angle and the second curve B having a negative tilt angle are gently connected to each other.

In the reflector 61 of the present embodiment, the maximum tilt angle δmax of each concave portion 63a, 63b, 63c, or the like varies irregularly within the range of 2 to 90°. However, the maximum tilt angles δmax of most of the concave portions vary irregularly within the range of 4 to 35°

Furthermore, the concave portion 63 has a single minimum point (a point on the curve where a tilt angle is zero) D on an internal surface thereof. A distance between the minimum point D and the surface S of the base substrate constitutes a depth d of the concave portion 63, and the depths d of the concave portions 63a, 63b, 63c, and the like vary irregularly within the range of 0.1 μm to 3 μm, respectively.

In the present embodiment, specific vertical sections X of the concave portions 63a, 63b, 63c, and the like face all in the same direction. In addition, the concave portions 63 are formed such that the respective first curves A are arranged in the same direction. That is, all concave portions are formed such that the x axes thereof shown in FIGS. 5 and 6 are arranged in the same direction.

In the reflector 61, since the respective first curves A are arranged in the same direction, reflective characteristics thereof are deviated from the specular direction with respect to the surface S of the base substrate, as shown in FIG. 7.

That is, as shown in FIG. 7, a light component K, which is a reflected light component of a light component J obliquely incident with respect to the x direction, is reflected from the surface S of the base substrate to lean to a direction H from a specular direction K₀, thereby shifting a bright display range.

As a result, from the viewpoint of the total reflective characteristic of the specific vertical section X, the reflective index of light reflected from the surface around the second curve B increases. Therefore, it is possible to obtain a reflective characteristic capable of appropriately converging reflected light in a specific direction.

That is, FIG. 8 is a view illustrating the relationship between an acceptance angle (θ°) and brightness (reflectance) in a case in which external light is incident, at an angle of 30°, on a display surface of the reflective bistable nematic liquid crystal device 1 of the present embodiment in which the asymmetric dimple reflector 61 is provided on a side opposite to the observer side, and then reflected light is received at an acceptance angle from a vertical position (0°) to 60°, centered on a specular reflection angle of 30° with respect to the display surface (the surface of the base substrate). As a comparative example, FIG. 8 also shows the relationship between an acceptance angle and reflectance in a reflective bistable nematic liquid crystal display device using a reflector having spherical concave portions thereon.

As apparently seen from FIG. 8, the comparative example shows substantially uniform reflectance in an acceptance angle range of about 15° to 45°. On the other side, in the reflective bistable nematic liquid crystal display device 1 of the present embodiment, an integral value of reflectance within the reflection angle range smaller than 30°, which is a specular reflection angle with respect to the surface S of the base substrate, is larger than an integral value of reflectance within the reflection angle range larger than the specular reflection angle. That is, it is possible to achieve sufficient brightness at a viewing angle of about 20°.

The asymmetric dimple reflector 61 can be manufactured in the following manufacturing method, but the invention is not limited to the following manufacturing method.

First, a punch whose tip has a convex shape corresponding to the concave portion is manufactured. Then, the tip of the punch is arranged to face an aluminum substrate such that the relative arrangement of the punch with respect to the aluminum substrate is maintained in the fixed direction. In this state, the entire surface of a predetermined region of the aluminum substrate is punched while irregularly changing a punching stroke and a punching interval. The punching stroke is controlled such that the concave portion is formed within a predetermined depth range. The punching interval or arrangement is adjusted so that a moiré shape is not generated.

In the reflective bistable nematic liquid crystal display device 1, the asymmetric reflector 61 is provided on the surface of the liquid crystal cell 35 opposite to the observer side such that the first curve A of each concave portion 63a, 63b, 63c, or the like is formed closer to the x direction than the second curve B having a slight tilt angle. In this way, for example, characters can be displayed with the x direction upward.

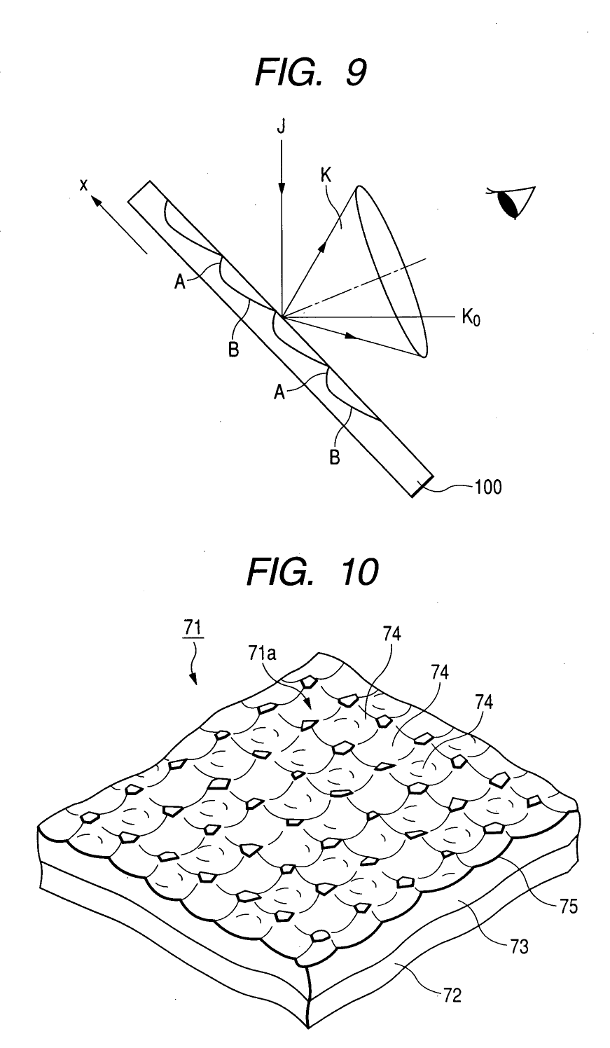

FIG. 9 is an explanatory diagram illustrating the use of the reflective bistable nematic liquid crystal display device 1 in which the asymmetric reflector 61 is provided on the surface of the liquid crystal cell 35 opposite to the observer side. For the sake of the convenience of explanation, only the first curves A and the second curves B of the reflective bistable nematic liquid crystal display device 1 are shown in FIG. 9, and the other components are not shown.

The reflective bistable nematic liquid crystal display device 1 is incorporated into an electronic book, an electronic organizer, or the like, with the x direction upward. In this case, generally, the reflective bistable nematic liquid crystal display device 1 is obliquely provided or maintained with respect to a horizontal surface, with the x direction upward, as shown in FIG. 9. That is, at the time of use, in each concave portion, the first curve A is provided at the more upper side than the second curve B, as viewed from an observer. Therefore, in general, the observer does not view the reflective bistable nematic liquid crystal display device 1 in the horizontal direction, but looks down it in the oblique direction.

In this case, reflected light K of external light (incident light J) incident from the upper side is mainly reflected from surfaces around the second curve B. Therefore, as described with reference to FIG. 8, the incident light is hardly reflected toward observer's feet, and is mainly reflected in a direction more upper than the specular reflection direction K₀.

Therefore, a general observation range of the observer coincides with a bright display range, and thus it is possible to implement a bright display device in practice.

(Example of Symmetric Dimple Reflector)

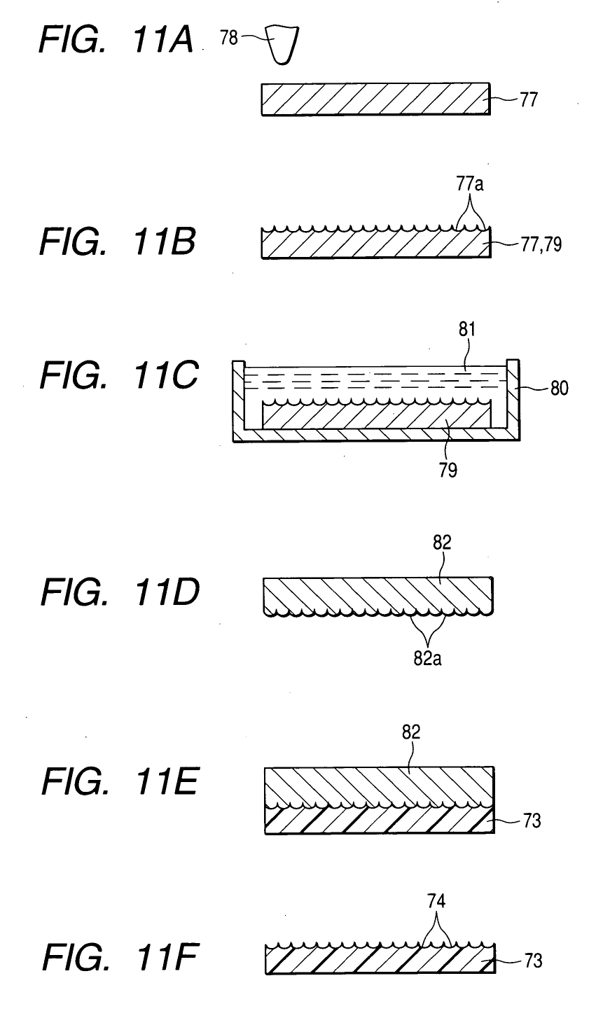

FIG. 10 is a view illustrating a symmetric dimple reflector 71 used for the reflector 11 of the present embodiment.

As shown in FIG. 10, in the symmetric dimple reflector 71 of the present embodiment, for example, a plurality of concave portions 74 whose internal surfaces each constitute a portion of a spherical surface are consecutively formed to overlap each other on a plate-shaped resin base substrate 73 (a base substrate for a reflector) composed of, for example, a photosensitive resin layer that is provided on a substrate 72 made of, for example, glass. Then, a thin reflective film 75 made of, for example, aluminum or silver, is formed thereon by a vapor deposition method or printing method. In this symmetric reflector 71, a surface of the reflective film 75 serves as a diffusing reflection surface 71a.

Preferably, the concave portions 74 are randomly formed with a depth of 0.1 to 3 μm, and a pitch between adjacent concave portions 74 is randomly set in the range of 5 to 50 μm. In addition, a tilt angle of the internal surface of each concave portion 74 is preferably set in the range of −18° to +18°.

In particular, it is important that the tilt angle of the internal surface of each concave portion 74 be set in the range of −18° to +18° and that the pitches between adjacent concave portions 74 be randomly set in all directions on the plane. The reason is that, if the pitches between adjacent concave portions 74 are regularly set, interference colors of light occur, which causes reflected light to be colored. In addition, when the tilt angle of the internal surface of each concave portion 74 is beyond the angular range of −18° to +18°, a diffusion angle of reflected light becomes too large, and thus the intensity of reflection is lowered. As a result, a bright reflective plate is not obtained (the diffusion angle of reflected light is larger than 36° in the air, and the peak of reflection intensity is lowered in a liquid crystal display device, which results in a large loss of total reflection).

Further, when the depth of the concave portion 74 is larger than 3 μm, the top of the concave portion 74 is not buried with an adhesive layer in a subsequent process of planarizing the concave portion 74, and thus desired flatness is not obtained.

When the pitch between adjacent concave portions 74 is smaller than 5 μm, there is a restriction in manufacturing a mother die for forming a reflector, and a processing time is excessively elongated. In addition, a reflector cannot be formed in a shape to obtain a desired reflection characteristic, and interference light occurs. Further, when a diamond indenter having a diameter of 30 to 100 μm is used for manufacturing a mother die for forming a reflector, the pitch between adjacent concave portions 74 is preferably set in the range of 5 to 50 μm.

Next, a method of manufacturing the reflector having the above-mentioned structure will be described with reference to FIGS. 11 to 14.

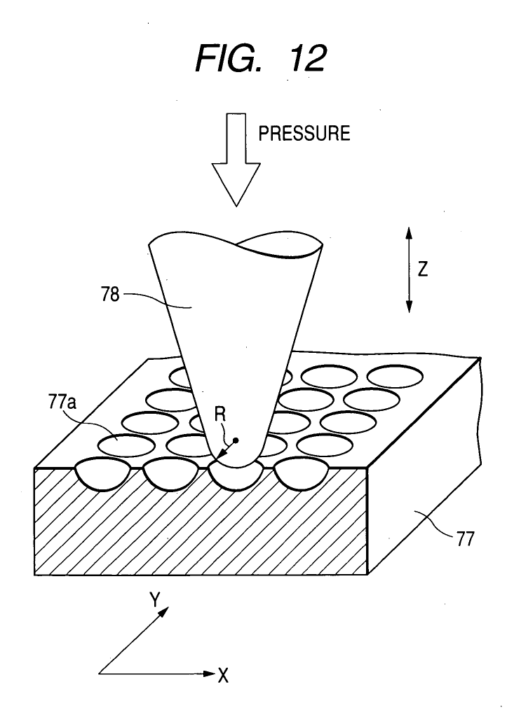

First, as shown in FIG. 11A, a plate-shaped mother substrate 77 made of, for example, brass, stainless steel, or tool steel is fixed to a table of a rolling machine. The diamond indenter 78 whose tip has a spherical shape having a predetermined diameter R is repeatedly pressed against the surface of the mother substrate 77 in the vertical direction plural times while moving the mother substrate 77 in the horizontal direction, so that a plurality of concave portions 77a having different depths and pitches are formed on the surface of the mother substrate 77, thereby obtaining a mother die 79 for forming a reflector, as shown in FIG. 11B. As shown in FIG. 12, in the rolling machine used therefor, the table for fixing the mother substrate 77 moves in the X and Y directions on a horizontal plane with a resolution of 0.1 μm, and the diamond indenter 78 moves in the vertical direction (Z direction) with a resolution of 1 μm. In addition, the diameter R of the tip of the diamond indenter 78 is preferably in the range of about 20 to 100 μm. For example, when the depth of the concave portion 77a is about 2 μm, a diamond indenter whose tip has a diameter R of 30 to 50 μm may be used. In addition, when the depth of the concave portion 77a is about 1 μm, a diamond indenter whose tip has a diameter R of 50 to 100 μm may be used.

Furthermore, a rolling process by the diamond indenter is performed as follows.

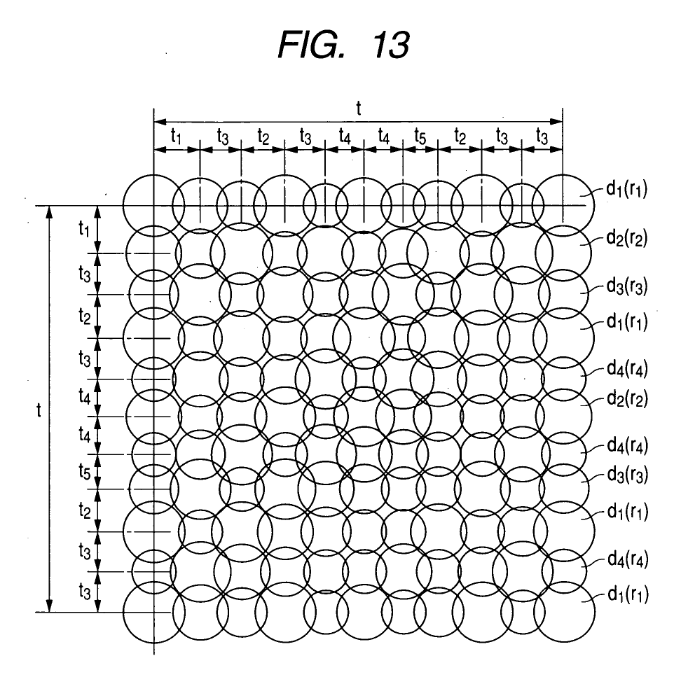

FIG. 13 is a plan view illustrating a rolling pattern. As shown in FIG. 13, pitches between adjacent concave portions in a row are arranged in the order of t₁ (=17 μm), t₃ (=15 μm), t₂ (=16 μm), t₃, t₄ (=14 μm), t₄, t₅ (=13 μm), t₂, t₃, and t₃ from the left to the right. In addition, a pitch between adjacent concave portions in a column is arranged in the same pattern as described above from an upper side to a lower side. Further, four kinds of concave portions having a depth of 1.1 to 2.1 μm are formed by pressing (four values are represented by d₁, d₂, d₃, and d₄ in FIG. 13), so that the circularly concave portions formed by pressing have four kinds of radiuses r1 (=11 μm), r2 (=10 μm), r3 (=9 μm), and r4 (=8 μm). For example, the concave portions having radiuses r1, r2, r3, r1, r4, r2, r4, r3, r1, r4, and r1 in this order are arranged in a column from the upper side to the lower side.

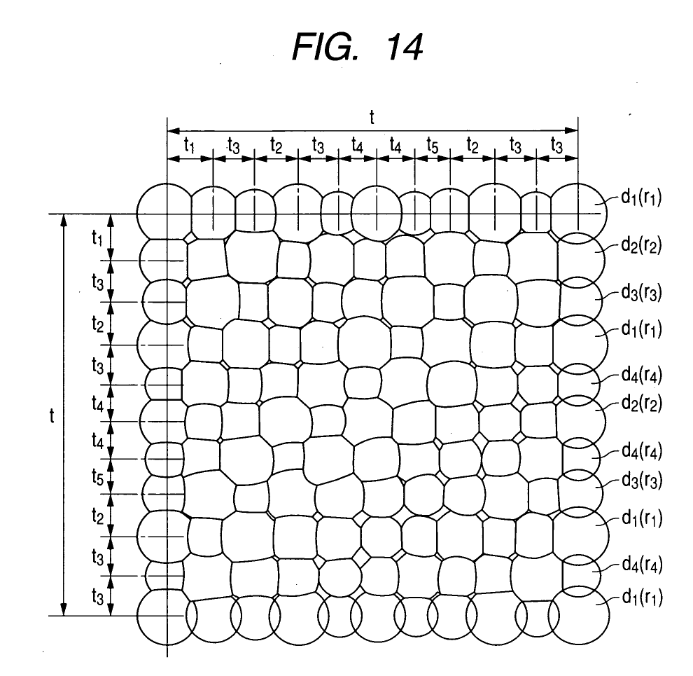

Furthermore, according to the actual rolling order, in the uppermost row, the concave portions having a depth d₁ are formed at intervals, and then the concave portions having depths d₂, d₃, and d₄ are sequentially formed by repeatedly performing a rolling operation for forming four patterns of depths, thereby forming the uppermost row of concave portions. Then, the same operation is repeatedly performed on a second row from the upper side. In this way, all concave portions are formed. In addition, FIG. 13 shows a square-shaped rolling pattern having a size of 150 μm by 150 μm, and the entire reflector is constituted by consecutively arranging this pattern. As shown in FIG. 13, since adjacent concave portions partially overlap each other, the plan view of all concave portions after the rolling operation is completed is as shown in FIG. 14.

Then, as shown in FIG. 11C, the mother die 79 is encased in a box-shaped case 80, and the case 80 is filled with a resin material 81, such as silicon. Then, the resin material is left at room temperature to be hardened. Then, the hardened resin product is extracted from the case 80, and unnecessary portions are removed. Subsequently, as shown in FIG. 1D, it is manufactured a transfer mold 82 having a plurality of convex portions reverse to a plurality of concave portions formed on the surface of the mother die 79 on a mold surface 82a thereof.

Then, a photosensitive resin solution, such as an acryl-based resist, a polystyrene-based resist, an azido rubber-based resist, or an imide-based resist, is applied on an upper surface of a glass substrate by a coating method, such as a spin coating method, a silkscreen method, or a spraying method. After the coating process is completed, the photosensitive resin solution on the substrate is heated by a heating apparatus, such as a hot plate or a heating furnace, at a temperature range of 80 to 100° C. for one or more minutes, which is called a pre-bake process, thereby forming a photosensitive resin layer on the substrate. However, since different pre-bake conditions are used according to the type of photosensitive resin used, it goes without saying that the heating process may be performed beyond the above-mentioned temperature and time ranges. In addition, it is preferable that the photosensitive resin layer formed in this way have a thickness of 2 to 5 μm.

Thereafter, as shown in FIG. 1E, the mold surface 82a of the transfer mold 82 shown in FIG. 11D is pressed against the photosensitive resin layer 73 on the glass substrate for a predetermined time, and then the transfer mold 82 is separated from the photosensitive resin layer 73. In this way, as shown in FIG. 11F, concave portions on the mold surface 82a of the transfer mold is transferred onto the surface of the photosensitive resin layer 73, thereby forming a plurality of concave portions 74. In addition, it is preferable that pressure at the time of pressing be selected according to the kind of photosensitive resin used. For example, a pressure of 30 to 50 kg/cm² is preferable. Further, it is preferable that a pressing time be selected according to the kind of photosensitive resin used. For example, a pressing time of 30 seconds to 10 minutes is preferable.

Then, light beams, such as ultraviolet rays (g, h, and i rays) are irradiated onto the photosensitive resin layer 73 through a back surface of the transparent glass substrate to harden the photosensitive resin layer 73. In this case, the light beams, such as ultraviolet rays, preferably have an intensity of more than 50 mJ/cm², which is a sufficient amount of intensity to harden this type of photosensitive resin layer. In addition, it goes without saying that a light beam having intensity beyond the above-mentioned intensity range may be irradiated according to the kind of photosensitive resin layer. Then, the photosensitive resin layer 73 on the glass substrate is heated at a temperature of, for example, 240° C. for one or more minutes using the same heating apparatus as that used in the pre-bake process, such as a heating furnace or a hot plate, which is called a post-bake process, thereby baking the photosensitive resin layer 73 on the glass substrate.

Finally, a metallic material, such as aluminum, is coated on the photosensitive resin layer 73 by an electron beam vapor deposition method to form a reflective film 75 on the surfaces of the concave portions, thereby completing the symmetric dimple reflector 71 of the present embodiment.

In the symmetric dimple reflector 71 of the present embodiment, a plurality of concave portions 74 whose internal surfaces each constitute a portion of a spherical surface are formed on the surface thereof such that the depths of the concave portions 74 and the pitch between adjacent concave portions 74 are set in the above-mentioned ranges. Therefore, the tilt angle of the internal surface of the concave portion has a predetermined distribution within a predetermined angular range. For example, FIG. 15 shows the distribution of the tilt angle of the internal surface of the concave portion in the reflector 71 of the present embodiment. In FIG. 15, the horizontal axis indicates a tilt angle, and the vertical axis indicates the number of tilt angles. As shown in FIG. 15, the tilt angle has a substantially uniform distribution in the angular range of −18 to +18°, particularly in the angular range of −10 to +10°. In addition, since the internal surface of the concave portion 74 is a spherical surface and is symmetric with respect to all directions, the uniform distribution of the tilt angle is realized in all directions, not in a specific direction.

It is considered that a reflection angle of reflected light from the internal surface of the concave portion depends on the tilt angle of the internal surface of the concave portion. In the case of the present embodiment, since the distribution of the tilt angles is uniform in all directions of the reflector, uniform reflection angle and reflection efficiency are obtained in all directions. Thus, it is possible to reflect light having various wavelengths with a good balance. That is, it is possible to realize a bright, white reflective plate as viewed from any direction.

Further, when the mother die 79 for forming a reflector is manufactured, the diamond indenter just moves in the vertical direction toward the mother substrate 77 to press the surface thereof. Therefore, the diamond indenter 78 does not rub against the mother substrate 77. As a result, the surface state of the tip of the diamond indenter 78 is reliably transferred onto the mother die 79. When the tip of the indenter 78 is formed in a mirror surface shape, it is possible to allow the internal surfaces of the concave portions of the mother die 79 and the internal surfaces of the concave portions of a reflector to have mirror surface shapes.

Furthermore, unlike a conventional reflector whose uneven surface is formed by heating a resin film made of, for example, polyester, the dimensions, such as depths, diameters, and pitches, and the surface states of the concave portions of the symmetric reflector of the present embodiment can be controlled. Therefore, it is possible to manufacture concave portions of a reflector as designed by using a rolling machine having high precision. Thus, this method can more easily control reflection characteristics of a reflective plate to be manufactured, such as a reflection angle and reflection efficiency, than a conventional manufacturing method, and thus it is possible to obtain a desired reflector.

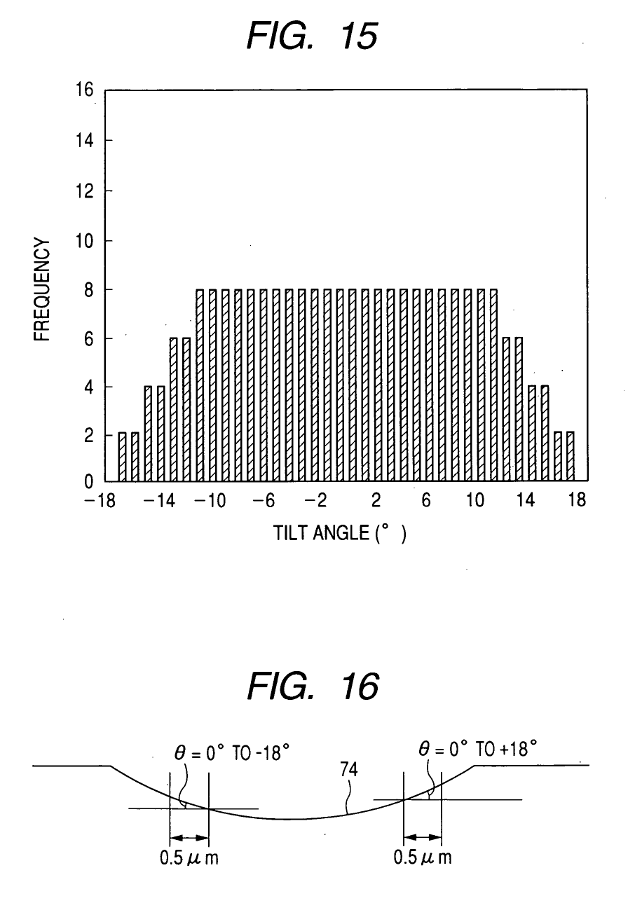

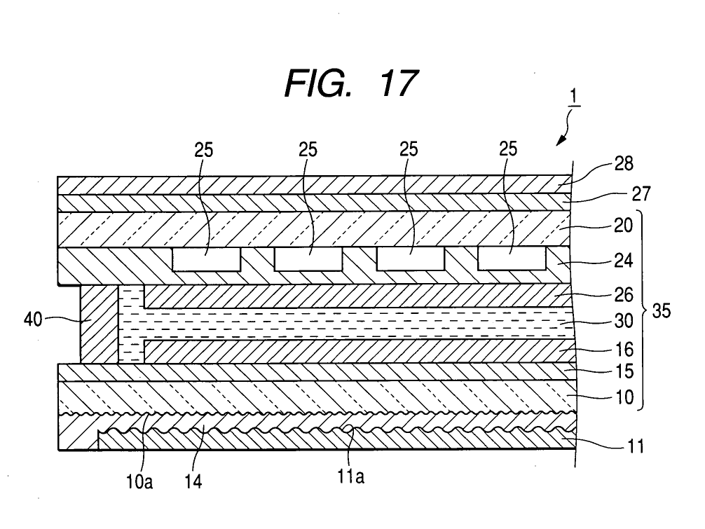

The term ‘depth of the concave portion of the reflector 71’ means a distance from the surface of the reflector to the bottom thereof, and the term ‘pitch between adjacent concave portions’ means a distance between the centers of concave portions having a circular shape in plan view. In addition, the term ‘tilt angle of the internal surface of the concave portion’ means an angle θ of an inclined surface with respect to the horizontal surface in a very narrow width range of 0.5 μm at a predetermined place on the internal surface of the concave portion 74, as shown in FIG. 16. The angle θ is defined such that an inclined surface positioned at the right side of a normal line with respect to the surface of the reflector has a positive value and an inclined surface positioned at the left side thereof is a negative value.

Further, in the present embodiment, the dimensions of the concave portions 74 of the reflector, such as depths, diameters, and pitches, and the rolling pattern of the concave portions shown in FIG. 13 are given as only an example, and the present embodiment is not limited thereto. Thus, it goes without saying that various modifications and changes of the invention can be made. In addition, materials forming various substrates, such as a substrate for a reflector and a substrate for a mother die, can be properly changed, and a material forming the transfer mold can also be properly changed.

Furthermore, in the above-mentioned embodiment, the first alignment film 16 provided on the surface of the first substrate 10 facing the liquid crystal layer, which is opposite to the observer side, is composed of an alignment film having strong anchoring energy, and the second alignment film 26 provided on the surface of the second substrate 20 facing the liquid crystal layer, which is the observer side, is composed of an alignment film having weak anchoring energy. However, the first alignment film 16 may be composed of an alignment film having weak anchoring energy, and the second alignment film 26 may be composed of an alignment film having strong anchoring energy.

Moreover, of a pair of substrates constituting the liquid crystal cell 35, the first substrate 10 is provided opposite to the observer side, and a surface of the first substrate 10 facing the reflector may serve as a light scattering surface 10a having a light scattering property, and the light scattering surface 10a may have unevenness on a surface thereof. In this case, the transmissive adhesive layer 14 provided between the reflector 11 and the light scattering surface 10a is made of a material having a different refractive index from the material forming the first substrate 10, in addition to having high reliability as an adhesive and a characteristic without generating, for example, air bubbles.

When the adhesive layer 14 and the first substrate 10 have the same refractive index, light is not scattered at the outer surface 10a (the light scattering surface) of the first substrate 10, which is a boundary between the first substrate 10 and the adhesive layer 14. Therefore, in order to remove a rainbow from a display screen, which is an expected object, by scattering light at the outer surface 10a (the light scattering surface) of the first substrate 10, a difference in refractive index between the adhesive layer 14 and the first substrate 10 is preferably larger than 0.01. In addition, when the difference in refractive index between two members is excessively large, the reflection characteristic is greatly deviated from the design value. Therefore, the difference in refractive index is preferably smaller than 0.2.

For example, when the first substrate 10 is a glass substrate, the refractive index thereof is about 1.52. Therefore, the adhesive layer 14 can be made of a resin material having a refractive index of about 1.32 to 1.72, such as acryl resin (refractive index: 1.46), fluorine resin (refractive index: 1.34), or epoxy resin (refractive index: 1.61). For example, the adhesive layer 14 is made of a transparent resin material, such as epoxy-based resin containing fluorine.

Further, in the above-mentioned embodiment, the reflective bistable nematic liquid crystal display device of the invention is applied to a passive matrix reflective liquid crystal display device. However, the invention is not limited thereto, and can be applied to a transflective liquid crystal display device in which a plurality of transmissive holes is formed in a reflector or a reflective liquid crystal display device in which a front light is provided on the observer side of the liquid crystal cell 35. When the invention is applied to the transflective liquid crystal display device, a polarizing plate and a backlight are provided on a side of the liquid crystal cell opposite to the observer side. In addition, in the above-mentioned embodiment, a monochrome-display-type liquid crystal display device has been described. However, the invention can be applied to a color-display-type liquid crystal display device. When the invention is applied to the color-display-type liquid crystal display device, color filters are provided between the liquid crystal cell and the reflector, on an inner surface (a surface facing the liquid crystal layer) of the first substrate 10, or on an inner surface (a surface facing the liquid crystal layer) of the second substrate 20.

As described above, the invention provides a reflective bistable nematic liquid crystal display device in which two alignment films having strong and weak anchoring energies are stably provided and which can be manufactured with a simple manufacturing process.

Such a reflective bistable nematic liquid crystal display device can be applied to electronic apparatuses, such as an electronic book and an electronic organizer, in which data that has been displayed, such as characters, is maintained for a long time until the data is reset. In addition, the reflective bistable nematic liquid crystal display device of the invention can stably display an image even if display is switched, and can improve display quality.

Further, in the reflective bistable nematic liquid crystal display device of the invention, the reflector provided on the outer surface of the liquid crystal cell serves as the asymmetric dimple reflector (or the symmetric dimple reflector), so that the brightness of reflected light and the viewing angle characteristic of the reflector can be asymmetrically (or symmetrically) controlled with respect to a normal line of a liquid crystal panel. In this way, the reflector can endow the reflection characteristic suitable for the actual state of use of portable information terminals, such as an electronic book and an electronic organizer. Thus, the reflective bistable nematic liquid crystal display device can obtain bright display in the necessary viewing angle range of observation.

1. A reflective bistable nematic liquid crystal display device comprising:
a liquid crystal cell; and
a reflector provided on a side of the liquid crystal cell opposite to an observer side, with a transmissive adhesive layer interposed therebetween,
wherein the liquid crystal cell includes a pair of substrates opposite to each other, with a nematic liquid crystal layer in which a chiral agent is added therebetween, one of the pair of substrates having electrodes and an alignment film with strong anchoring energy in this order on a surface thereof facing the liquid crystal layer, and the other of the pair of substrates having electrodes and an alignment film with weak anchoring energy in this order on a surface thereof facing the liquid crystal layer,
the alignment film having the strong anchoring energy is formed to have a predetermined pre-tilt angle,
the alignment film having the weak anchoring energy is composed of a polymer film having shape anisotropy on at least one surface thereof and is formed to have anchoring energy smaller than half of that of the alignment film having strong anchoring energy and to have a pre-tilt angle of about 0°,
a surface of the reflector facing the liquid crystal cell serves as a diffusing reflection surface having unevenness or a plurality of concave portions thereon, and
liquid crystal molecules of the liquid crystal layer in the liquid crystal cell are controlled to be arranged in one of two stable states.

2. The reflective bistable nematic liquid crystal display device according to claim 1,
wherein the alignment film having weak anchoring energy has an anchoring energy of 6×10⁻⁵ J/m² to 2×10⁻⁴ J/m².

3. The reflective bistable nematic liquid crystal display device according to claim 1,
wherein, in the reflector, a plurality of reflective concave portions is formed on a base substrate, and each of the plurality of reflective concave portions has a curved internal surface,
each concave portion has a specific vertical section passing through a lowest point thereof,
the specific vertical section is composed of a first curve linking a circumferential portion of the concave portion to the lowest point and a second curve connected to the first curve to link the lowest point to another circumferential portion,
an average value of the absolute values of tilt angles of the first curve with respect to a surface of the base substrate is larger than an average value of the absolute values of tilt angles of the second curve with respect to the surface of the base, substrate,
a maximum value of the absolute values of the tilt angles of the first curve with respect to the surface of the base substrate is in the range of 40 to 35°,
the plurality of concave portions are irregularly formed with a depth of 0.1 μm to 3 μm, and
the base substrate is obliquely provided with respect to a horizontal surface such that the second curve of each concave portion is placed downward at a position close to an observer and the first curve thereof is placed upward at a position separated from the observer.

4. The reflective bistable nematic liquid crystal display device according to claim 1,
wherein a plurality of concave portions whose internal surfaces each constitute a portion of a spherical surface are consecutively formed in a shape corresponding to a shape of an indenter on a surface of the reflector facing the liquid crystal cell such that the edges of adjacent concave portions overlap each other, by pressing the indenter whose tip has a spherical shape against a base substrate at a random pitch and a random depth,
the concave portions are randomly formed with a depth of 0.1 to 3 μm,
a pitch between adjacent concave portions is randomly set, and
a tilt angle of an internal surface of each concave portion has a uniform angular distribution within the range of −10° to +10°.

5. The reflective bistable nematic liquid crystal display device according to claim 1,
wherein a plurality of concave portions whose internal surfaces each constitute a portion of a spherical surface are consecutively formed in a shape corresponding to a shape of an indenter on a surface of the reflector facing the liquid crystal cell such that the edges of adjacent concave portions overlap each other, by pressing the indenter whose tip has a spherical shape against the base substrate at a random pitch and a random depth,
the concave portions are randomly formed with a depth of 0.1 to 3 μm,
a pattern in which a pitch between adjacent concave portions is randomly set is repeatedly arranged to form a surface of the reflector,
a tilt angle of an internal surface of each concave portion has a uniform angular distribution within the range of −10° to +10°,
a diffusion angle of reflected light is set in a predetermined angular range on the entire surface of the reflector, and
a pattern in which the concave portions having different depths, pitches, and diameters are formed in a region defined by predetermined rows and columns is repeatedly formed in succession, so that the concave portions are randomly formed on the entire surface of the reflector.

6. The reflective bistable nematic liquid crystal display device according to claim 1,
wherein a plurality of concave portions is formed on a mother substrate by pressing an indenter whose tip has a spherical shape against a mother substrate such that depths of the plurality of concave portions are randomly set by a pressed depth of the indenter, such that pitches between the concave portions are randomly set by the pressed position of the indenter, and such that edges of adjacent concave portions overlap each other,
a transfer mold is formed from the mother substrate by a transfer method,
a reflector is formed by transferring an unevenness pattern of the transfer mold onto a resin layer, so that a plurality of concave portions whose internal surfaces each constitute a portion of a spherical surface are consecutively formed in a shape corresponding to the shape of the indenter on a surface of the reflector,
the concave portions are randomly formed with a depth of 0.1 to 3 μm, and
a pattern in which the concave portions having different depths, pitches, and diameters are formed in a region defined by predetermined rows and columns is repeatedly formed in succession, so that the concave portions are randomly formed on the entire surface of the reflector.

7. The reflective bistable nematic liquid crystal display device according to claim 1,
wherein one of the pair of substrates of the liquid crystal cell, the substrate being provided at a side opposite to the observer side, has a light scattering surface having a light scattering property on a surface thereof facing the reflector, and the light scattering surface has unevenness thereon.
